(19) United States
(12) Patent Application Publication
(10) Pub. No.: US 2015/0285830 A1
(43) Pub. Date: Oct. 8, 2015

(54) SAMPLE PRETREATMENT APPARATUS AND SAMPLE PRETREATMENT METHOD

(71) Applicants: Gang Woong Lee, Seoul (KR); Bum Ju Khang, Incheon (KR); Song Bum Choi, Gyeonggi-do (KR); Eun Hee Kim, Gyeonggi-do (KR)

(72) Inventors: Gang Woong Lee, Seoul (KR); Bum Ju Khang, Incheon (KR); Song Bum Choi, Gyeonggi-do (KR); Eun Hee Kim, Gyeonggi-do (KR)

(21) Appl. No.: 14/423,518

(22) PCT Filed: Aug. 24, 2012
(86) PCT No.: PCT/KR2012/006753

§ 371 Date: Jun. 2, 2015

(51) Int. Cl. G01N 35/10; G01N 1/40; G01N 1/28

(52) U.S. Cl. CPC G01N 35/10; G01N 1/28; G01N 1/40

(57) ABSTRACT

A sample retreatment apparatus is disclosed, the apparatus including: a sample inlet unit configured to inject a sample including an analysis subject substance; a gas supply unit configured to supply a gas to the sample inlet unit, a sample purge unit, and a sample injection unit; a sample purge unit configured to vaporize the analysis subject substance in the sample by agitating the injected sample in a decompression state; a sample collection unit configured to reduce a press of the sample purge unit and to collect the analysis subject substance; and a sample injection unit configured to outlet the analysis subject substance to an analysis device.

### BACKGROUND

1. Field of the Disclosure

The present disclosure relates to a sample retreatment apparatus and a sample pretreatment method. More particularly, the present disclosure relates to a sample retreatment apparatus and a sample retreatment method to effectively separate an analysis subject substance included in a sample, through an agitation process in a decompression state.

2. Discussion of the Related Art

In general, an analysis subject substance included in a liquid or solid sample passes through a series of pretreatment processes to separate and concentrate the analysis subject substance from the sample, before the analysis subject substance is analyzed with a device such as a GC (Gas chromatography).

For such sample pretreatment process, a method is commonly used to collect and concentrate an analysis subject substance for a certain period of time, after vaporizing the analysis subject substance included in the sample in the air.

Currently, sample retreatment methods such as Headspace, Purge and Trap, and SPME (Solid Phase Micro Extraction) are widely used. The Headspace method is as follows: A sample is injected into a container sealed with a barrier membrane. The injected sample is heated in a predetermined temperature. At this time, volatile components included in the sample move up to a space above the sample. The vaporized analysis subject substance is injected to a sample analysis device by using a syringe, or is automatically injected to the sample analysis device through a connection tube heated with a carrier gas.

The Purge and Trap method is as follows: A liquid or solid sample is put into a container and injected with an inert gas. Volatile components included in the sample are volatilized with the inert gas. The analysis subject substance volatilized with the inert gas is collected by an adsorption trap. When the purge is completed after a predetermined period of time, the adsorbed analysis subject substance is desorbed from the adsorption trap, by expeditiously heating the adsorption trap. The Purge and Trap method is suitable for analyzing a tiny amount of volatile component existing in the liquid sample, because the volatile component is concentrated in the adsorption trap.

### SUMMARY OF THE DISCLOSURE

A technical challenge that the present disclosure intends to achieve is to provide a sample retreatment apparatus and a sample retreatment method configured to expeditiously separate an analysis subject substance from a tiny amount of sample and concentrate the analysis subject substance.

In a general aspect of the present disclosure, there is provided a sample retreatment apparatus comprising: a sample inlet unit configured to inject a sample including an analysis subject substance; a gas supply unit configured to supply a gas to the sample inlet unit, a sample purge unit, and a sample injection unit; a sample purge unit configured to vaporize the analysis subject substance in the sample by agitating the injected sample in a decompression state; a sample collection unit configured to reduce a press of the sample purge unit and to collect the analysis subject substance; and a sample injection unit configured to outlet the analysis subject substance to an analysis device.

In some exemplary embodiments of the present disclosure, the sample inlet unit may control an injected amount of the sample, and may supply the gas of the gas supply unit to the sample purge unit.

In some exemplary embodiments of the present disclosure, the sample purge unit may include: a sample purge tube configured to store the sample injected through the sample inlet unit; and an agitator configured to agitate the sample in a decompression state.

In some exemplary embodiments of the present disclosure, the sample collection unit may include: a syringe pump configured to control a pressure of the sample purge unit; a second control valve configured to control an injection of the analysis subject substance injected through the syringe pump; and a pressure measurement unit configured to measure a pressure of the sample purge unit.

In some exemplary embodiments of the present disclosure, the sample injection unit may include: a third control valve configured to control a flow of the analysis subject substance; and a sample circular canal configured to inject the analysis subject substance to the analysis device by being connected to the third control valve.

In some exemplary embodiments of the present disclosure, the sample retreatment apparatus may further comprise: a heating unit configured to heat the sample purge unit, the sample collection unit, and the sample injection unit.

In some exemplary embodiments of the present disclosure, the gas supply unit may include: a nano-valve configured to supply an air to the sample purge unit by controlling the air by a unit of nanoliter.

In some exemplary embodiments of the present disclosure, the sample retreatment apparatus may further comprise: a controller configured to control the sample inlet unit, the gas supply unit, the sample purge unit, the sample collection unit, and the sample injection unit.

In some exemplary embodiments of the present disclosure, the sample retreatment apparatus may further comprise: a heating unit configured to heat the sample purge unit, the sample collection unit, the sample injection unit, and a connection tube.

In some exemplary embodiments of the present disclosure, the sample retreatment apparatus may further comprise: a temperature measurement unit configured to measure and control temperatures of the sample purge unit, the sample collection unit, the sample injection unit, and the heating unit.

In another general aspect of the present disclosure, there is provided a sample retreatment method comprising: supplying a sample including an analysis subject substance to a sample purge unit by injecting the sample; decompressing the sample purge unit injected with the sample; agitating the sample by supplying a gas of a gas supply unit through a nano-valve in a decompression state; extracting and collecting the analysis subject substance in air separated from the sample; concentrating the collected analysis subject substance; and supplying the analysis subject substance to an analysis device.

According to an exemplary embodiment of the present disclosure, the sample retreatment process may be expedited, and the analysis time may be saved. In addition, according to an exemplary embodiment of the present disclosure, a more precise analysis may be conducted, by separating and concentrating an analysis subject substance, without change in description of the analysis subject substance, in the air from a tiny amount of the sample below 1 ml.

### BRIEF DESCRIPTION OF THE DRAWINGS

FIG. 1 is a block diagram illustrating a structure of a sample pretreatment apparatus according to an exemplary embodiment of the present disclosure.

FIG. 2 is a block diagram illustrating a sample pretreatment apparatus according to an exemplary embodiment of the present disclosure in connection with an analysis device.

FIG. 3 is a perspective view illustrating a sample pretreatment apparatus according to an exemplary embodiment of the present disclosure.

FIG. 4 is a flow chart illustrating a sample pretreatment method according to an exemplary embodiment of the present disclosure by steps.

FIG. 5 is an experiment result of comparing reproducibility, analytical limit, recovery rate, and straightness for the purpose of measuring the effect of a sample pretreatment method according to an exemplary embodiment of the present disclosure.

### DETAILED DESCRIPTION

Various exemplary embodiments will be described more fully hereinafter with reference to the accompanying drawings, in which some exemplary embodiments are shown. The present inventive concept may, however, be embodied in many different forms and should not be construed as limited to the exemplary embodiments set forth herein. Rather, the described aspect is intended to embrace all such alterations, modifications, variations, and equivalents that fall within the scope and novel idea of the present disclosure.

The terms including ordinal numbers such as “first” or “second” may be used for description of various elements. However, the elements shall not be limited by such the terms. The terms are used merely to distinguish a particular element from another element. For example, a first component may be referred to as a second component without departing from the scope of rights of the present disclosure, and likewise a second component may be referred to as a first component.

When a component is mentioned to be “connected” to or “accessing” another component, this may mean that it is directly connected to or accessing the other component, but it is to be understood that another component may exist in-between.

The terms used in the present specification are merely used to describe particular embodiments, and are not intended to limit the present invention. An expression used in the singular encompasses the expression of the plural, unless it has clearly different meaning in the context.

In the present specification, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

In addition, the figures enclosed in the present disclosure are to be understood as to be illustrated by being enlarged or downsized for convenience of description.

Herein, the present disclosure will be described in detail with reference to the enclosed figures. The same number is given to an identical or corresponding component regardless of figure symbols, and the overlapped description thereof will be omitted.

Hereinafter, referring to accompanying drawings, an exemplary embodiment according to the present disclosure will be described in detail.

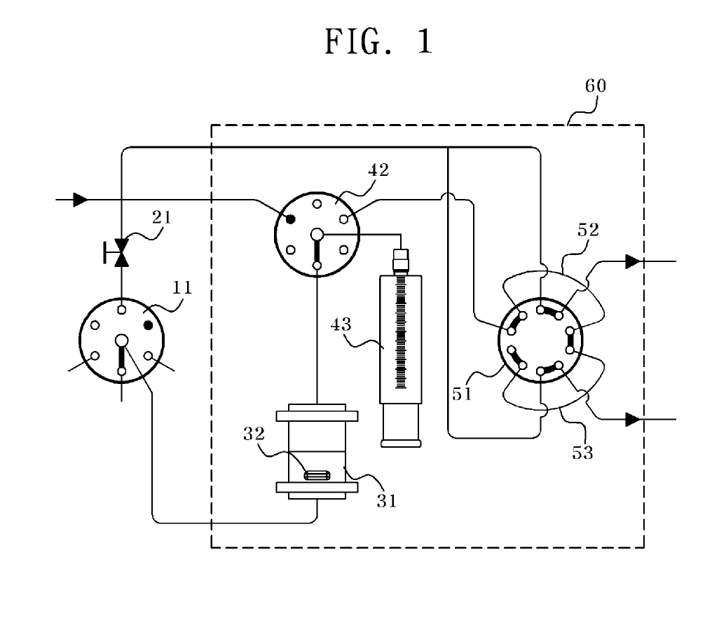

FIG. 1 is a block diagram illustrating a structure of a sample pretreatment apparatus according to an exemplary embodiment of the present disclosure.

As illustrated in FIG. 1, a sample retreatment apparatus (100) according to an exemplary embodiment of the present disclosure may include a sample inlet unit (10), a gas supply unit (20), a sample purge unit (30), a sample collection unit (40), and a sample injection unit (50).

The sample inlet unit (10) may supply a sample including an analysis subject substance to the sample purge unit (20). The sample inlet unit (10) may include a first control valve (11). The first control valve (11) may control an injected amount of the sample, and may supply the gas of the gas supply unit (20) to the sample purge unit (30).

The gas supply unit (20) may supply a gas to the sample inlet unit (10), a sample purge unit (30), and a sample injection unit (50), when required. The gas supplied by the gas supply unit (20) may be an inert gas such as helium or an atmosphere.

The gas supply unit (20) may further include a nano-valve (21). The nano-valve (21) may control the amount of the air inhaled when purging by a unit of nanoliter. Dilution of the analysis subject substance due to the gas in the sample purge unit (30) may be prevented, by minutely controlling amount of the gas in the nano-valve (21).

The sample purge unit (30) may include a sample purge tube (31) and an agitator (32).

The sample purge tube (31) may be supplied with a sample through the sample inlet unit (10).

The sample purge tube (31) may agitate the sample by using the agitator (32) in a decompression state. The analysis subject substance may be easily volatilized because the agitating is performed in the decompression state.

The sample collection unit (40) may include a syringe pump (41).

The interior of the sample purge tube (31) may become a decompression state, when the air is inhaled by the syringe pump (41) and the tiny amount of gas by a unit of nanoliter is injected from the nano-valve (21).

The volatilized analysis subject substance is moved to a syringe of the syringe pump (41) from the sample purge tube (31), due to pressure difference between the sample purge tube (31) and the syringe pump (41).

A pyrex glass or a general glass may be selectively used as the sample purge unit (30). In addition, the volume of the sample may be 1˜5 ml to minimize the dead volume. In addition, the sample purge unit (30) may further include a pressure measurement unit (33).

The pressure measurement unit (33) may ascertain whether the environment is maintained for the analysis subject substance to be effectively volatilized, by detecting the decompression state of the sample purge tube (31).

The sample collection unit (40) may include a syringe pump (41) and a second control valve (42). A syringe (43) of the syringe pump (41) may inlet the analysis subject substance in the air separated from the sample purge unit (30). The syringe (43) may collect and concentrate the analysis subject substance. The syringe (43) installed at the syringe pump (41) may be of a gastight type.

The second control valve (42) may be located at a syringe entrance of the syringe pump (41), and may control flow of the analysis subject substance.

The sample purge unit (30) may be connected to the sample collection unit (40) by a connection tube.

The connection tube (70) may be made of a stainless steel material. In addition, the connection tube (70) may prevent adsorption of the analysis subject substance by adopting a special coating on the inside thereof.

The analysis subject substance collected in the sample collection unit (40) may be sent to the sample injection unit (50).

The sample injection unit (50) may send the analysis subject substance to an analysis device by being connected to the analysis device.

For this purpose, the sample injection unit (50) may include a third control valve (51). That is, the third control valve (51) may control the flow of the analysis subject substance and may send to the analysis device.

Therefore, the sample retreatment apparatus according to an exemplary embodiment of the present disclosure may be directly connected to the analysis device, and may perform the process from sample retreatment to sample analysis in a lump.

In addition, the gas supply unit (20) may supply a carrier gas, by being connected to sample circular canals (52, 53) installed at the third control valve (51). The carrier gas may help to inject the analysis subject substance in the air to the analysis device.

The sample retreatment apparatus according to an exemplary embodiment of the present disclosure may further include a heating unit (60).

The heating unit (60) may be provided outside of the sample purge unit (30), the sample collection unit (40), and the sample injection unit (50). The heating unit (60) may prevent condensation of the analysis subject substance in the air, by heating the sample purge unit (30), the sample collection unit (40), the sample injection unit (50), and connection tubes of each component.

The temperature of the heating unit (60) may be 80° C.˜150° C., and may vary according to characteristics of the analysis subject substance. The heating unit (60) may be selected and adopted from various known methods in the art.

In addition, the sample retreatment apparatus according to an exemplary embodiment of the present disclosure may include a controller (not illustrated in the figure) to control the sample retreatment process.

The controller (70) may control the connection state between each component of the sample inlet unit (10), the gas supply unit (20), the sample purge unit (30), the sample collection unit (40), the sample injection unit (50), and the heating unit (60), may control flow and operation of the sample, or may process the measured value. Especially, the controller (70) may control the sample inlet unit (10), the sample purge unit (20), the sample collection unit (30), the first control valve (30), the second control valve (40), and the third control valve (50) to control the sample retreatment process, based on inputs form the user.

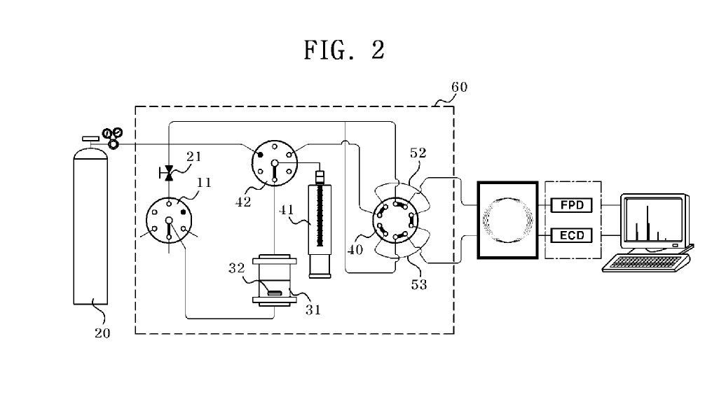

FIG. 2 is a block diagram illustrating a sample pretreatment apparatus according to an exemplary embodiment of the present disclosure in connection with an analysis device.

The sample retreatment apparatus (100) according to an exemplary embodiment of the present disclosure may be directly connected to an analysis device.

The sample circular canals (52, 53) installed at the third control valve (51) may be connected so that the sample can be delivered to an analysis device such as a gas chromatography device. Therefore, the sample retreatment device may perform the process from sample retreatment to sample analysis in a lump, by extracting the analysis subject substance from the sample and by sending to the analysis device.

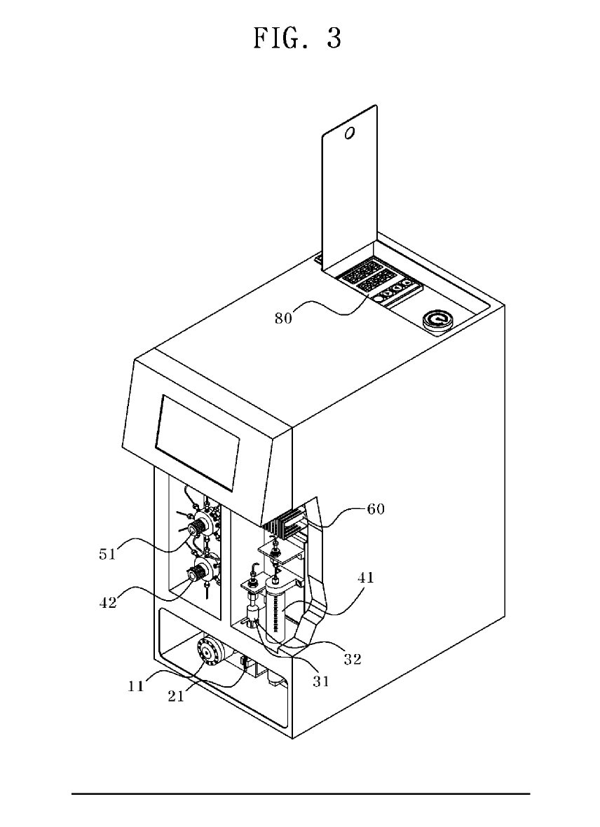

FIG. 3 is a perspective view illustrating a sample pretreatment apparatus according to an exemplary embodiment of the present disclosure.

As illustrated in FIG. 3, the sample retreatment apparatus according to an exemplary embodiment of the present disclosure may further include a temperature controller (80).

The temperature controller (80) may maintain the suitable temperature for the retreatment process by constantly measuring the temperature of the heating unit (60).

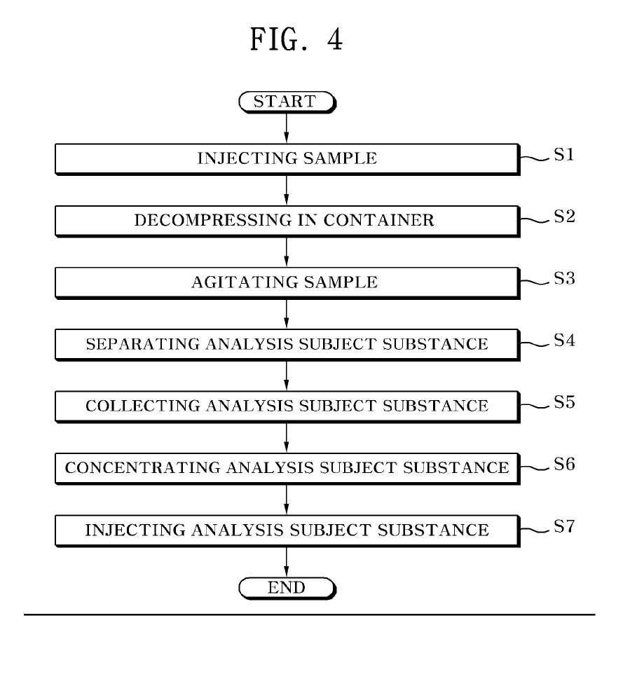

FIG. 4 is a flow chart illustrating a sample pretreatment method according to an exemplary embodiment of the present disclosure by steps.

As illustrated in FIG. 4, the sample retreatment method according to an exemplary embodiment of the present disclosure may include a step of injecting a sample (S1), a step of decompressing the sample purge unit (30) (S2), a step of agitating in the sample purge unit (30) (S3), a step of separating the analysis subject substance (S4), a step of collecting the analysis subject substance (S5), a step of concentrating the analysis subject substance (S6), and a step of injecting the analysis subject substance to the analysis device (S7).

At first, a sample may be injected through a sample inlet unit (10), by obtaining the sample (S1).

That is, the sample is injected to a first control valve (11) (S1), and is moved to the sample purge unit (30). When the sample is moved to the sample purge unit (30), the pressure in the sample purge tube (31) is decompressed by using the syringe pump (41) of the sample collection unit (40) (S2).

The sample in the sample purge tube (31) is agitated by using an agitator (32) in the decompression state (S3). An analysis subject substance is separated from the sample in the decompression and agitation state (S4). Here, the micro-air injected by a unit of nanoliter accelerates separation of the analysis subject substance.

Thus, dilution effect may be minimized, and concentration effect of the analysis subject substance may be increased, because the agitator (32) agitated the sample and the analysis subject substance was separated by using a tiny amount of purging gas by a unit of nanoliter. That is, the sample retreatment efficiency may be enhanced, as well as the performance time for sample retreatment may be reduced.

The separated analysis subject substance in the air is collected in a sealed space (S5).

The second control valve (42) prevents dilution of the analysis subject substance, by sealing the syringe (43), at the entrance of the syringe (43). In addition, the temperature of the container is maintained within a predetermined range of temperature (80˜150° C.), to prevent condensation of the analysis subject substance.

Next, the analysis subject substance is concentrated (S6). In the concentration step, the collected analysis subject substance in the air is blocked from the outside. The controller (80) renders the pressure inside of the syringe (43) same as the atmospheric pressure. Here, the pressure measurement may be selected and adopted from various known pressure measurement means in the art.

At last, the concentrated analysis subject substance is delivered to the sample analysis device through the sample injection unit (50) (S7).

Through the above series of steps, the sample retreatment process may be finally completed.

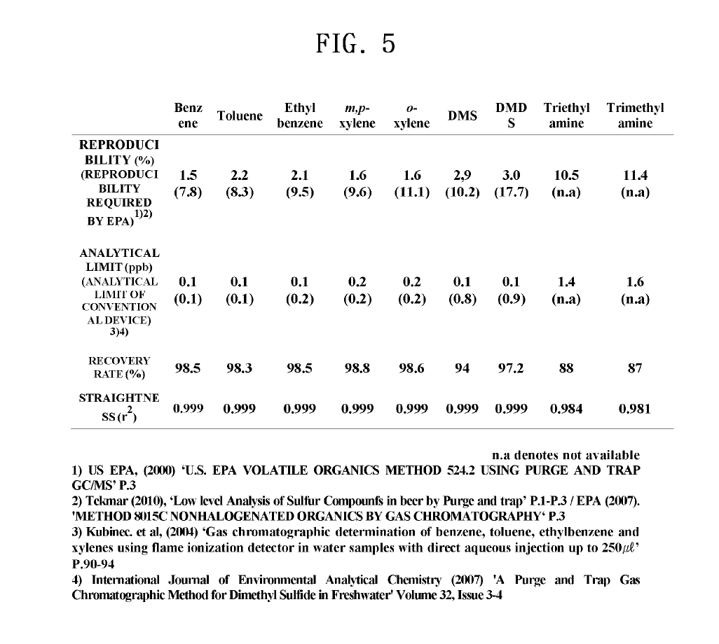

FIG. 5 is an experiment result of comparing reproducibility, analytical limit, recovery rate, and straightness for the purpose of measuring the effect of a sample pretreatment method according to an exemplary embodiment of the present disclosure.

For the purpose of evaluating straightness of the analysis subject substance, various concentrations of BTEX (Benzene, Toluene, Ethyl benzene, and Xylenes), DMDS (Dimethyl Disulfide), and a standard sample in amines standard sample were analyzed. Sample concentrations of the standard sample were produced and analyzed as 1.25 ppb, 5 ppb, 10 ppb, 20 ppb, 50 ppb, and 100 ppb.

The straightness of all samples were presented as R²=0.999, which showed highly excellent straightness. Some amines showed low straightness to some degrees, which may not affect the analysis. That is, a highly excellent effect in straightness was obtained as a result of processing the standard sample by using the sample retreatment apparatus according to an exemplary embodiment of the present disclosure.

In addition, a recovery rate can be found as in the following:

η(%)=(R₁−R₂)/R₁×100,
where R₁=concentration at first analysis, and R₂=concentration at second analysis.

The recovery rate of the device was found, by experimenting on the same sample twice repeatedly, through result values of the first and the second analysis.

At first, a 100 ppb standard material was used, for the purpose of experimentation on recovery rate of the device. After retreating and analyzing the 100 ppb standard sample, the sample was retreated and analyzed again, not being discarded. The recovery rate was calculated by the above equation. As a result of the calculation, the recovery rate was represented as above 98%.

In the present experimentation, the analytical limit was calculated by using the result of analyzing sample values of twenty 0.125 ppb standard samples after retreatment.

As illustrated in FIG. 5, analytical limits equal or superior to a conventional retreatment device were represented. Furthermore, analytical limits of DMS (Dimethyl Sulfide), DMDS, and amines were represented as superior to analytical limits of a conventional retreatment device.

As a result of performing a reproducibility experiment by a method similar to the analytical limit experimentation, the performance was represented to superior to the reproducibility required by EPA (Environmental Protection Agency).

As described in the above, the sample retreatment process, by using the sample retreatment apparatus according to an exemplary embodiment of the present disclosure, in a decompression condition of around 0.05 atmosphere, by using continuous agitations of liquid sample and a tiny amount of clean air, may enhance deaeration efficiency of organic compounds, and may expeditiously perform the retreatment process.

The abovementioned exemplary embodiments are intended to be illustrative, and not to limit the scope of the claims. Many alternatives, modifications, variations, and equivalents will be apparent to those skilled in the art. The features, structures, methods, and other characteristics of the exemplary embodiments described herein may be combined in various ways to obtain additional and/or alternative exemplary embodiments within an equivalent scope. Therefore, the technical scope of the rights for the present disclosure shall be decided by the claims.

What is claimed is:

1. A sample retreatment apparatus, comprising:
a sample inlet unit configured to inject a sample including an analysis subject substance;
a gas supply unit configured to supply a gas to the sample inlet unit, a sample purge unit, and a sample injection unit;
a sample purge unit configured to vaporize the analysis subject substance in the sample by agitating the injected sample in a decompression state;
a sample collection unit configured to reduce a press of the sample purge unit and to collect the analysis subject substance; and
a sample injection unit configured to outlet the analysis subject substance to an analysis device.

2. The apparatus of claim 1, wherein
the sample inlet unit controls an injected amount of the sample, and supplies the gas of the gas supply unit to the sample purge unit.

3. The apparatus of claim 1, wherein the sample purge unit includes:
a sample purge tube configured to store the sample injected through the sample inlet unit; and
an agitator configured to agitate the sample in a decompression state.

4. The apparatus of claim 1, wherein the sample collection unit includes:
a syringe pump configured to control a pressure of the sample purge unit;
a second control valve configured to control an injection of the analysis subject substance injected through the syringe pump; and
a pressure measurement unit configured to measure a pressure of the sample purge unit.

5. The apparatus of claim 1, wherein the sample injection unit includes:
a third control valve configured to control a flow of the analysis subject substance; and
a sample circular canal configured to inject the analysis subject substance to the analysis device by being connected to the third control valve.

6. The apparatus of claim 1, further comprising:
a heating unit configured to heat the sample purge unit, the sample collection unit, and the sample injection unit.

7. The apparatus of claim 1, the gas supply unit includes:
a nano-valve configured to supply an air to the sample purge unit by controlling the air by a unit of nanoliter.

8. The apparatus of claim 1, further comprising:
a controller configured to control the sample inlet unit, the gas supply unit, the sample purge unit, the sample collection unit, and the sample injection unit.

9. The apparatus of claim 1, further comprising:
a heating unit configured to heat the sample purge unit, the sample collection unit, the sample injection unit, and a connection tube.

10. The apparatus of claim 9, further comprising:
a temperature measurement unit configured to measure and control temperatures of the sample purge unit, the sample collection unit, the sample injection unit, and the heating unit.

11. A sample retreatment method comprising:
supplying a sample including an analysis subject substance to a sample purge unit by injecting the sample;
decompressing the sample purge unit injected with the sample;
agitating the sample by supplying a gas of a gas supply unit through a nano-valve in a decompression state;
extracting and collecting the analysis subject substance in air separated from the sample;
concentrating the collected analysis subject substance; and
supplying the analysis subject substance to an analysis device.

12. The method of claim 11, wherein
the step of agitating the sample includes supplying an inert gas by a unit of nanoliter by using the nano-valve.
